(19) United States
(12) Patent Application Publication
(10) Pub. No.: US 2019/0009751 A1
(43) Pub. Date: Jan. 10, 2019

(54) WIPER FRAME ELEMENT WITH AT LEAST ONE CHANNEL FOR DISTRIBUTING WINDSHIELD WIPER FLUID

(71) Applicant: Valeo Systèmes d'Essuyage, Le Mesnil Saint Denis (FR)

(72) Inventors: Samuel Papazian, Le Mesnil Saint Denis (FR); Frédéric Giraud, Le Mesnil Saint Denis (FR)

(73) Assignee: Valeo Systèmes d'Essuyage, Le Mesnil Saint Denis (FR)

(21) Appl. No.: 16/069,792

(22) PCT Filed: Jan. 19, 2017
(86) PCT No.: PCT/EP2017/051112

§ 371 Date: Jul. 12, 2018

(30) Foreign Application Priority Data
Jan. 19, 2016 (FR) 1650399

(51) Int. Cl. B60S 1/52; B60S 1/38

(52) U.S. Cl. CPC B60S 1/524; B60S 2001/3898; B60S 1/3881; B60S 1/381

(57) ABSTRACT

The invention relates to an element (14) for a wiper frame, comprising at least one channel (45a, 45b) for the distribution of windshield wiper fluid and characterized in that means (49) for spreading the fluid are provided in the at least one channel (45a, 45b) in the element (14).

### TECHNICAL FIELD

The present invention relates to the field of cleaning the windshield of a vehicle, in particular a motor vehicle. It concerns a wiper blade element provided with at least one channel for distributing windshield washer liquid, together with a windshield wiper blade including such an element. It also consists in a method of manufacturing the element.

### PRIOR ART

It is known to spray windshield washer liquid from fixed nozzles on a fixed part of a motor vehicle such as the hood.

A device of this kind has the significant disadvantage of calling for nozzles that are necessarily far from the windshield, which makes it difficult to obtain homogenous spraying of the windshield.

What is more, the sprayed liquid tends to be strongly deflected toward the bottom of the windshield when the vehicle is traveling at high speed.

To remedy this disadvantage, it has been proposed to integrate the windshield washer liquid distribution system into a windscreen wiper, and notably a windscreen wiper blade, in the form of one or more spraying pipes. Thus there have been designed windshield wiper blades including a system for the distribution of windshield washer liquid onto a window to be wiped of a motor vehicle, the blades including at least one substantially tubular longitudinal spraying pipe which includes an internal channel in which the windshield washer liquid circulates and orifices for spraying the window of the vehicle, and in which the pipe is fixed longitudinally to the windshield wiper and is connected to a circuit for feeding a windshield washer liquid under pressure by a feed pipe.

When distribution of the windshield washer liquid under pressure is stopped, some of the liquid remains inside the pipe or pipes of the blade, in particular in the form of droplets that remain immobilized at certain locations of the pipe. In the event of freezing, ice plugs can then be formed across the entire cross section of the pipe or pipes, rendering impossible any subsequent distribution of windshield washer liquid.

To solve this problem, there is known from the documents DE 102008051397 and DE 102009004943 a local heating device. However, that solution has the disadvantage of being complex and costly. It is moreover inoperative in the event of failure of the heating device.

The present invention aims to remedy these disadvantages, by proposing a wiper blade element providing a simple and effective way to prevent blocking of the pipes by ice plugs in the event of freezing.

### SUMMARY OF THE INVENTION

The invention therefore consists in a wiper blade element, comprising at least one channel for distributing windshield washer liquid.

According to the invention, said element comprises in said at least one channel means for spreading said liquid.

In the present invention, there is meant, by spreading means, means configured to spread the liquid longitudinally inside said at least one channel so that this liquid after spreading occupies less of the cross section of the channel than the section that it occupied before spreading. Accordingly, after spreading, the liquid no longer occupies the entire section of the channel. The spreading means may be means integrated into the element. They may for example be geometric means. The spreading means may in particular take the form of a groove, slot, channel or notch, formed in the element at the periphery of the channel and able to absorb by capillarity and/or by gravity at least some of the liquid. Alternatively, or cumulatively, the spreading means may be constituted by the shape of the channel itself, for example by a shape enabling spreading of the liquid by capillarity, typically by a channel provided with at least one longitudinal edge.

Accordingly, the presence of the spreading means advantageously makes it possible to spread the residual liquid in the channel and therefore to reduce the cross section of the ice plugs formed in the channel, so that the ice plugs no longer occupy the whole of the section of the channel, which allows subsequent passage of windshield washer liquid in the channel.

Said at least one channel being of elongate shape, the spreading means may extend longitudinally over at least a part of the length of said at least one channel, or even over substantially all the length of said at least one channel.

The spreading means are advantageously adapted to respect the minimum thickness of said at least one channel. The thickness of a channel is defined by the minimum distance between a point of said channel and the external envelope of the element that is the subject matter of the invention.

The minimum thickness of the channel is in particular provided to ensure correct behavior of the channel during the sweeping movements, in particular by preventing excessive deformation of the internal section of the pipe that would compromise the circulation of the liquid. The thickness of the channel at the level of the spreading means is therefore greater than or equal to the minimum thickness of the channel.

In a first embodiment, the spreading means may comprise at least one slot formed in the element at the periphery of said at least one channel and able to collect by capillarity and/or by gravity at least some of the liquid.

The slot may have any type of peripheral contour, for example a polygonal or curved peripheral contour. For spreading by capillarity, a polygonal peripheral contour will be preferred, and in particular a polygonal peripheral contour having at most six sides. When the channel is of circular section, the width of the slot at the level of the periphery of said channel, in cross section, preferably represents at most 30% of the diameter of the channel, and preferably between 2 and 15% of the diameter of the channel.

Each slot may for example have a peripheral contour in the shape of a U, a C or a V. In the case of a contour in the shape of a V, the acute angle formed by the branches of the V is preferably between 5° and 40° inclusive, in particular between 5° and 30° inclusive, even between 5° and 10°.

For better spreading by gravity, each slot is advantageously formed at the periphery of a lower zone of said at least one channel. In particular, each slot is advantageously formed in the element so that, in cross section, once the element is integrated into the blade, the acute angle between the longitudinal plane of symmetry of the slot and the longitudinal plane of symmetry of the blade is less than or equal to 45°. The longitudinal plane of symmetry of the blade is defined as being the longitudinal plane of symmetry of the squeegee of the blade.

The spreading means may comprise a plurality of slots, preferably two slots, and the spreading means may be formed at the periphery of a lower zone of said at least one channel. In particular, the element may comprise two channels and the spreading means may comprise in each channel two slots formed at the periphery of a lower zone of said channel. The element may in particular comprise two convergent slots and two substantially parallel slots.

In this first embodiment, said at least one channel is advantageously of curved, preferably circular section.

In a second embodiment, the spreading means include at least one longitudinal part of said at least one channel having at least one longitudinal edge, said at least one longitudinal part being in particular of polygonal cross section. In addition to this specific cross section of the channel, the spreading means may further comprise spreading means conforming to the first embodiment.

In the two embodiments, the element may be a cover element of the blade. In particular, the cover element may in particular comprise an aerodynamic deflector. Consideration may however be given to integrating the channel or channels into any type of element, for example into the body of the blade or into an element mounted on the body of the blade.

The invention also consists in a windshield wiper blade comprising an element as described hereinabove.

The blade may comprise an element comprising at least one slot formed in the element at the periphery of said at least one channel and able to absorb by capillarity and/or by gravity at least some of the liquid, each slot being formed at the periphery of a lower zone of said at least one channel, each slot being formed in the element so that, in cross section, the acute angle between the longitudinal plane of symmetry of the slot and the longitudinal plane of symmetry of the blade is less than or equal to 45°.

The invention also consists in a method of manufacturing a windshield wiper blade element as described hereinabove, the method comprising a step of formation of means for spreading liquid in said at least one channel.

The step of formation of the spreading means may comprise the formation in the element of at least one longitudinal slot at the periphery of said at least one channel.

The step of formation of the spreading means may comprise the formation in said at least one channel of at least one longitudinal part having at least one longitudinal edge.

In particular, the step of formation of the liquid spreading means may comprise the formation in said at least one channel of at least one longitudinal part of polygonal cross section.

### DESCRIPTION OF THE FIGURES

The invention will be better understood and other details, features and advantages of the invention will become apparent on reading the following description given by way of nonlimiting example and with reference to the appended drawings in which:

FIG. 1 is an exploded perspective view of a windshield wiper blade connected to the end of a windshield wiper arm,

FIG. 2 is a view in cross section of a prior art windshield wiper blade,

FIG. 3 is a view of the blade from FIG. 2 in longitudinal section taken along the line III-III,

FIG. 4 is a view in cross section of a prior art windshield wiper blade, the blade containing frozen residues of windshield washer liquid,

FIG. 5 is a view of the blade from FIG. 4 in longitudinal section taken along the line V-V,

FIGS. 6 and 9 are views in cross section of a windshield wiper blade according to the invention, conforming to a first embodiment,

FIG. 7 is a view in cross section of a windshield wiper blade from FIG. 6, the blade containing frozen residues of windshield washer liquid, and

FIG. 8 is a view of the blade from FIG. 7 in longitudinal section taken along the line VIII-VIII,

FIG. 10 is a view in cross section of a windshield wiper blade according to the invention, conforming to a first variant of the first embodiment,

FIG. 11 is a view in cross section of the blade from FIG. 10, in an operational configuration of the blade,

FIG. 12 is a view in cross section of a windshield wiper blade according to the invention, conforming to a second variant of the first embodiment, and

FIG. 13 is a view in cross section of a windshield wiper blade according to the invention, conforming to a second embodiment.

### DETAILED DESCRIPTION

In the description that follows, the terms longitudinal and lateral refer to the orientation of the windshield wiper blade according to the invention. The longitudinal direction corresponds to the principal axis of the blade along which it extends, whilst the lateral orientations correspond to straight lines that are concurrent, i.e. that cross the longitudinal direction, in particular that are perpendicular to the longitudinal axis of the blade in its plane of rotation. For the longitudinal directions, the terms exterior and interior are to be appreciated relative to the point at which the blade is fixed to a windshield wiper arm, the term interior corresponding to the part where the arm and a half-blade extend. Finally, the directions referred to as upper or lower correspond to orientations perpendicular to the plane of rotation of the windshield wiper blade, the term lower containing the plane of the windshield.

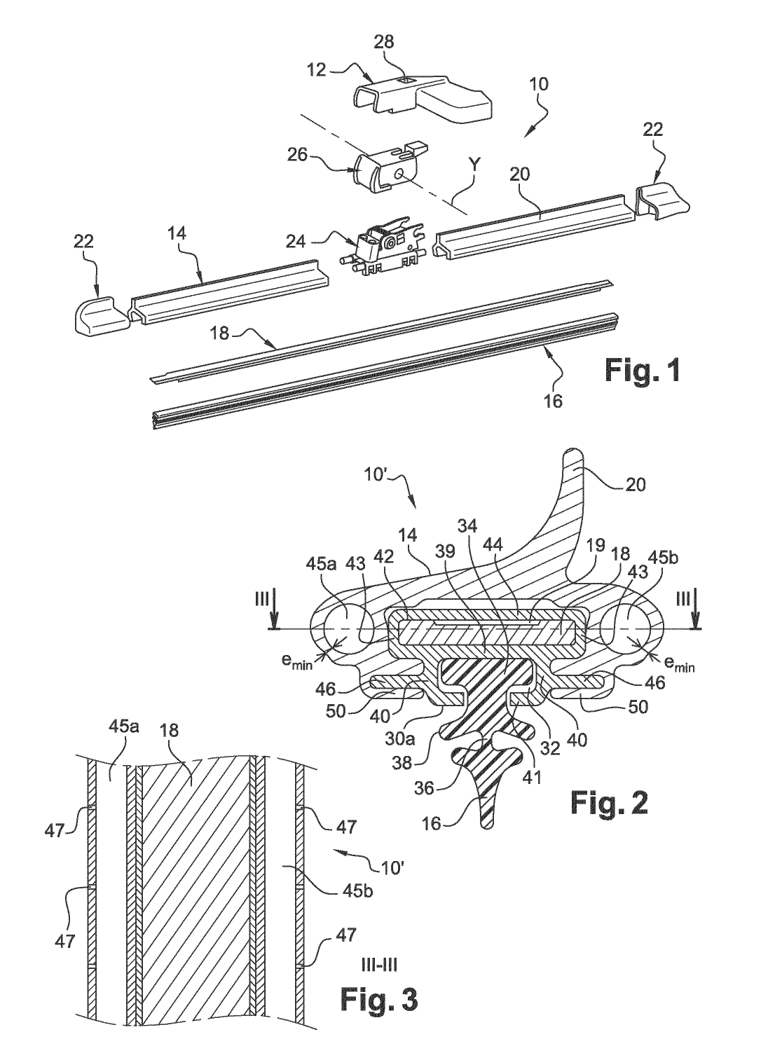

Referring to FIGS. 1 to 13, identical or functionally equivalent elements are identified by identical reference numbers.

There is shown in FIG. 1 a windshield wiper, in particular for a motor vehicle windshield, this windshield wiper comprising a longitudinal windshield wiper blade 10 and a windshield wiper arm 12 that is partially represented and intended to be driven by a motor to perform a to-and-fro angular movement enabling evacuation of water and where applicable other undesirable elements covering the windshield.

Here the blade 10 comprises a longitudinal cover element 14, a longitudinal squeegee 16, generally made of rubber, and at least one longitudinal spine 18 that stiffens the squeegee 16 so as to favor the application of this squeegee 16 to the windshield.

The cover element 14 of the blade 10 includes an upper aerodynamic deflector 20 intended to improve the operation of the windshield wiper, the object of this deflector 20 being to improve the pressing of the blade 10 onto the windshield and therefore the aerodynamic performance of the system.

The blade 10 further comprises tips or clips 22 for attaching the squeegee 16 and the spine 18 to the cover element 14, these clips 22 being situated at each of the longitudinal ends of the cover element 14.

Here the cover element 14 of the blade is produced in two independent parts that are disposed substantially end to end and separated from one another by an intermediate connector 24. This connector 24 is therefore inserted between the two parts of the cover element 14 and may comprise means for fluidic connection of means for feeding windshield washer liquid from the connector 24 to pipes of the element 14.

For mounting it on the arm 12, the blade 10 comprises an adapter 26 mounted on the connector 24 and allowing articulation of the blade 10 relative to the arm 12. The articulation of the blade 10 relative to the arm 12 is an articulation in accordance with a movement of rotation about a rotation axis Y perpendicular to the longitudinal axis of the blade 10. The blade 10 must in fact have at least one degree of freedom in rotation relative to the arm 12, and more specifically relative to an endpiece 28 of the arm 12, to allow the blade 10 to follow the curvature of the windshield.

FIG. 2 represents one embodiment of a prior art windshield wiper blade 10′, this blade 10′ comprising, in addition to the features described above with reference to FIG. 1, a longitudinal element 30a to support the squeegee 16 and the spine 18.

The support element 30a comprises two longitudinal lateral ribs 46, for example in the form of two blade-like members. These ribs 46 are substantially coplanar, each rib 46 extending laterally from the side opposite the other rib. The rib 46 situated at the front of the blade 10′ therefore extends forwards and the rib 46 situated at the rear of the blade extends rearwards.

The cover element 14 may comprise at least one longitudinal channel 45 for the passage of the windshield washer liquid, connected to appropriate distribution means, for example at the level of the connector 24. As shown in FIG. 2, the cover element 14 may comprise two channels 45a, 45b of circular section placed one on each side of the cover element 14, one channel 45a defining a bottom liquid distribution pipe and the other channel 45b defining a top liquid distribution pipe.

There has been shown in the FIG. 2 section the minimum thickness eₘᵢₙ of a channel 45a, 45b.

The cover element 14 of the blade further comprises at its lower end means of attachment to the support element 30a. In the example shown, the cover element 14 comprises two longitudinal lateral hooks 50 that are intended to cooperate with the ribs 46 of the support member 30a.

The hooks 50 are substantially coplanar and each defines a slot in which is mounted and in which can slide the support element 30a. The hook 50 situated at the front of the blade therefore extends rearwards and the hook 50 situated at the front of the blade extends forwards.

The support element 30a of the blade 10 also comprises a first housing or lower housing 32 receiving a longitudinal heel 34 of the squeegee 16. The squeegee 16 is for example of the fir tree shape type, well known to the person skilled in the art. Its upper end is connected by a hinge 36 and a damper element 38 to the heel 34. In known manner, in operation, the squeegee 16 may come to abut on the element 38 which damps its forward or rearward return.

The housing 32 is configured to receive the heel 34 of the squeegee 16 when it slides longitudinally. This housing 32 is delimited by a longitudinal bottom wall 39 and by two lateral walls 40. The upper edges of the lateral walls 40 are connected to the bottom wall 39 and their lower ends are each connected to a longitudinal rim 41. These rims 41 are substantially coplanar and extend toward one another. They delimit between them a slot in which is mounted and in which can slide a thinner lower part of the heel 34, which has a section substantially in the shape of a T.

The support element 30a comprises a second housing or upper housing 42 to receive the spine 18, which therefore extends above the heel 34 of the squeegee 16.

The housing 42 is configured to receive the spine 18 when it slides longitudinally. This housing 42 is delimited by the aforementioned bottom wall 39, by two lateral walls 43, and by an upper wall 44. The lower edges of the lateral walls 43 are connected to the bottom wall 39 and their upper edges are each connected to the upper wall 44.

The spine 18 has a curved shape when at rest and comprises a convex curved upper face and a concave curved lower face.

A heating element 19 such as a heating film of resistive material may be fixed to the upper face of the spine 18.

FIG. 3 is a view of the blade 10 from FIG. 2 in section taken along the line III-III. On each side of the spine 18, the channels 45a, 45b are provided with sprayer orifices 47 through which passes the windshield washer liquid that is directed by the effect of the pressure toward the windshield of the vehicle.

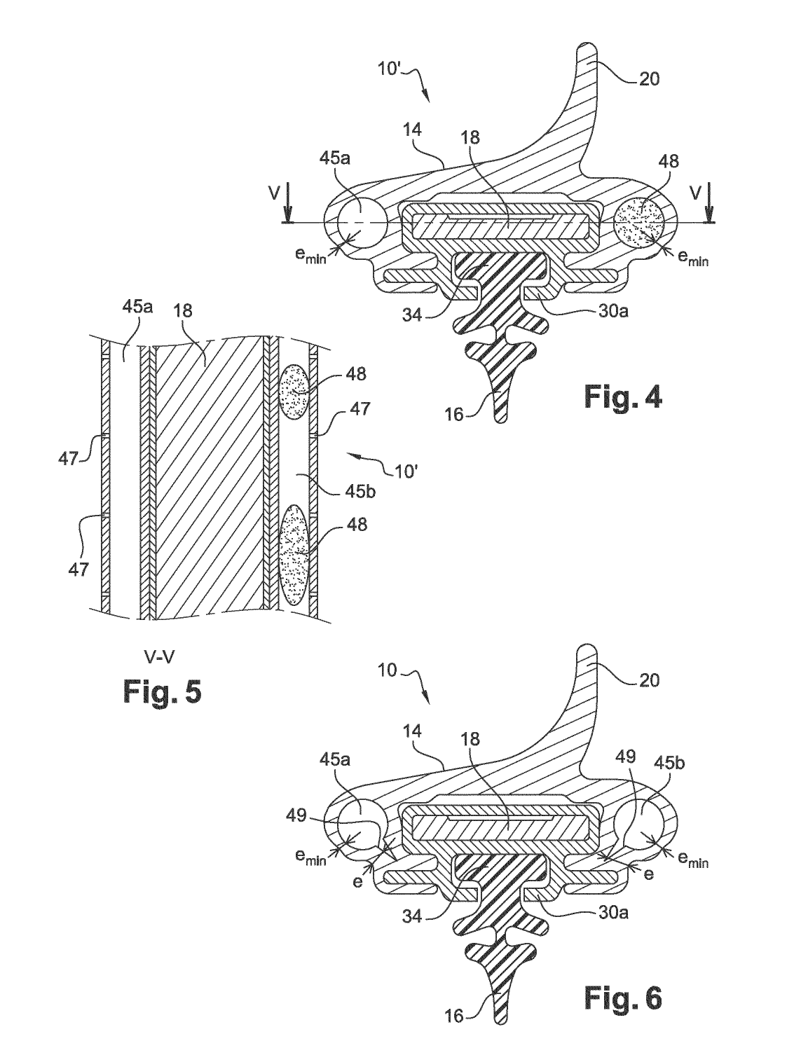

As shown in FIGS. 4 and 5, when distribution of the windshield washer liquid under pressure is stopped, some of the liquid may remain inside one or both channels 45a, 45b of the prior art blade 10′, in particular in the form of droplets that remain immobilized at certain locations of the pipe. In the event of freezing, ice plugs 48 may then be formed in the channels 45a, 45b, rendering impossible any subsequent distribution of windshield washer liquid. In FIGS. 4 and 5 there have been represented ice plugs 48 formed in the top pipe 45b.

According to the invention, at least one of the channels 45a, 45b of the blade 10, and preferably each of them, is provided with spreading means.

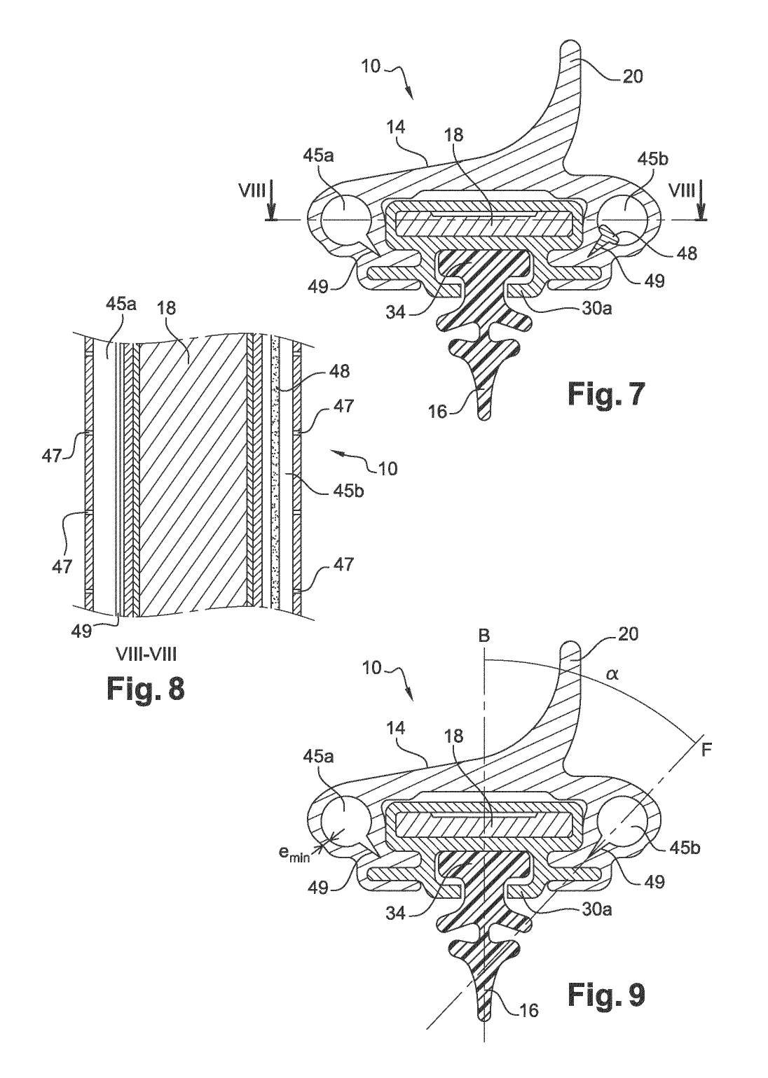

In a first embodiment, as shown in FIG. 6, the spreading means take the form of slots or grooves 49, formed in the element 14 at the periphery of the channels 45a, 45b and spread over one or more longitudinal portions of the blade 10, preferably over the entire length of the blade 10 (FIG. 6). The slots 49 allow absorption by capillarity of at least some of the residual liquid that may be present in the channels 45a, 45b after distribution of the liquid is stopped. During absorption, the liquid is spread longitudinally, and consequently the ice plug 48 likewise (FIG. 8). After spreading, the residual liquid is accommodated in part inside the circular portion of the channel 45b and in part in the exterior portion of the channel 45b constituted by the slot 49. Accordingly, the liquid no longer occupies all of the cross section of the channel 45b and the frozen droplets 48 no longer block the channel 45b (FIG. 7).

The slots 49 are intended to absorb the liquid by capillarity and/or by gravity. They may have in cross section any type of peripheral contour, for example a polygonal or curved peripheral contour.

It is seen in the FIG. 6 section that the thickness e of the channels 45a, 45b, defined by the minimum distance between a point of said channel and the external envelope of the element 14, is not minimal at the level of the spreading means 49. The thickness e of the channel 45a, respectively 45b, at the level of the spreading means is greater than or equal to the minimum thickness emirs of the channel, or even strictly greater than the latter as shown in FIGS. 6 and 9.

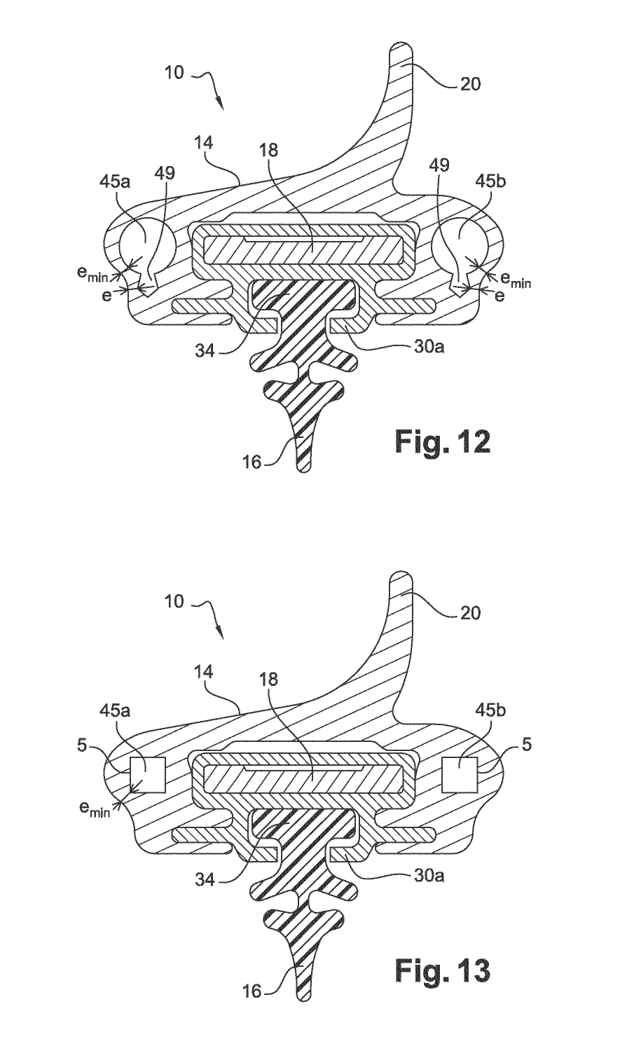

For spreading by capillarity, preference will be given to a polygonal peripheral contour, for example slots in the shape of a triangle (a V) as shown in FIGS. 9 to 11. Another example of the slots 49 is shown in FIG. 12 in which the slots have a pentagonal peripheral contour. The higher the internal area of the slots 49, the greater the capillary effect. As shown in FIGS. 9 to 12, the thickness e of the channel 45a, respectively 45b, at the level of the spreading means is greater than or equal to the minimum thickness eₘᵢₙ of the channel.

To reinforce the effect of capillarity by gravity, the slots 49 are advantageously formed in a lower part of the channels 45a, 45b, so that in cross section their axes of symmetry are not greatly inclined relative to the vertical in the operational configuration of the blade 10. Accordingly, for spreading to be favored by gravity, the acute angle α between the longitudinal plane of symmetry F of the slot 49 and the longitudinal plane of symmetry B of the blade 10 is advantageously less than or equal to 45° (FIG. 9). The longitudinal plane of symmetry B of the blade 10 is defined as being the longitudinal plane of symmetry of the squeegee 16.

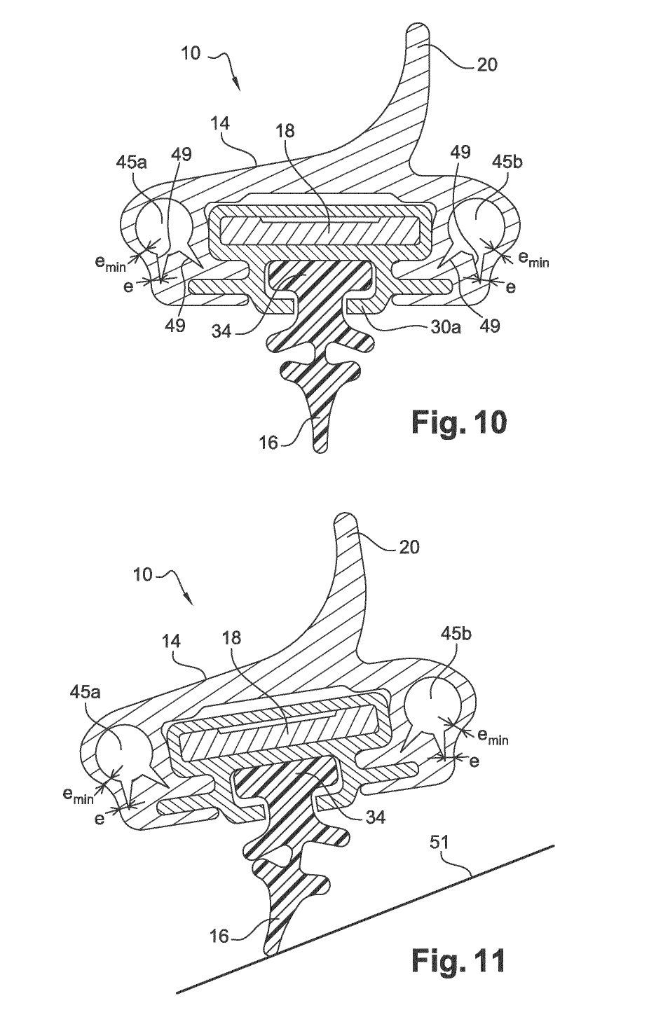

Alternatively, still to benefit from the effect of gravity, the channels 45a, 45b may each comprise at least two longitudinal slots 49 formed in a lower part of the blade 10 (FIG. 10). Accordingly, even if the blade 10 is inclined when it is in operation on a windshield 51, one of the two slots 49 is always close to the vertical (FIG. 11). Of the four slots 49, two are convergent and two are substantially parallel.

In a second embodiment, which may be combined with the first embodiment, the spreading means are constituted by at least one longitudinal portion of the blade 10, preferably the entire length of the blade 10, in which the cross section S of the channels 45a, 45b features at least one corner (or edge). In this embodiment, it is the corner or corners of the channels 45a, 45b that generate the capillarity. The channels 45a, 45b therefore typically have a polygonal cross section S, for example a square section S as shown in FIG. 13.

A method of manufacturing the blade 10 according to the invention may comprise a step of formation of the spreading means in at least one of the channels 45a, 45b of the element 14.

According to the first embodiment, the formation of the spreading means comprises, for example during the extrusion of the channels 45a, 45b of the element 14, the formation of at least one longitudinal slot 49 at the periphery of at least one of the channels 45a, 45b.

According to the second embodiment, the step of formation of the spreading means comprises, for example during the extrusion of the channels 45a, 45b of the element 14, the formation of at least one longitudinal angular part in at least one of the channels 45a, 45b. In this case, the longitudinal angular part is advantageously of polygonal cross section S in at least one of the channels 45a, 45b.

1. An element for a windshield wiper blade, comprising:
at least one windshield washer liquid distribution channel,
wherein said element comprises in said at least one channel, means for spreading said liquid.

2. The element as claimed in claim 1, wherein the thickness of the channel at the level of the spreading means is greater than or equal to the minimum thickness of the channel.

3. The element as claimed in claim 1, wherein said at least one channel is of elongate shape, the spreading means extend over at least a part of the length of said at least one channel, or even over substantially all the length of said at least one channel.

4. The element as claimed in claim 1, wherein the spreading means comprise at least one slot formed in the element at the periphery of said at least one channel and able to collect by capillarity and/or by gravity at least some of the liquid.

5. The element as claimed in claim 1, wherein the spreading means are formed at the periphery of a lower zone of said at least one channel.

6. The element as claimed in claim 4, wherein the spreading means comprise a plurality of slots.

7. The element as claimed in claim 5, further comprising two channels.

8. The element as claimed in claim 1, wherein the spreading means include at least one longitudinal part of said at least one channel having at least one longitudinal edge, said at least one longitudinal part being of polygonal cross section.

9. The element as claimed in claim 1, wherein the element is a cover element of the blade comprising an aerodynamic deflector.

10. A windshield wiper blade comprising the element as claimed in claim 9.

11. The blade as claimed in the preceding claim 10, wherein each slot is formed in the element so that, in cross section, the acute angle between the longitudinal plane of symmetry of the slot and the longitudinal plane of symmetry of the blade is less than or equal to 45°.

12. A method of manufacturing a windshield wiper blade element as claimed in claim 1, comprising formation of liquid spreading means in said at least one channel.

13. The method as claimed in claim 12, wherein formation of the spreading means comprises the formation in the element of at least one longitudinal slot at the periphery of said at least one channel.

14. The method as claimed in claim 12, wherein formation of the spreading means comprises the formation in said at least one channel of at least one longitudinal part having at least one longitudinal edge.

15. The method as claimed in claim 12, wherein formation of the spreading means comprises the formation in said at least one channel of at least one longitudinal part of polygonal cross section.
